(19) United States
(12) Patent Application Publication
(10) Pub. No.: US 2019/0103945 A1
(43) Pub. Date: Apr. 4, 2019

(54) Repetition And Hybrid Automatic Repeat Request Process Determination For Grant-Free Transmission In Mobile Communications

(71) Applicant: MediaTek Singapore Pte. Ltd., Singapore (SG)

(72) Inventors: Abdelkader Medles, Cambridge (GB); Mehmet Kunt, Cambridge (GB); Mohammed S Aleabe Al-Imari, Cambridge (GB); Pradeep Jose, Cambridge (GB); Abdellatif Salah, Cambridge (GB); Arnaud Cupillard, Cambridge (GB)

(21) Appl. No.: 16/145,155

(22) Filed: Sep. 27, 2018

Related U.S. Application Data
(60) Provisional application No. 62/565,183, filed on Sep. 29, 2017.

(51) Int. Cl. H04L 1/18; H04L 5/00; H04W 72/12; H04L 1/00

(52) U.S. Cl. CPC H04L 1/1854; H04L 5/0051; H04L 1/0038; H04W 72/1278; H04L 1/1861; H04L 1/1812

(57) ABSTRACT

Various solutions for repetition and hybrid automatic repeat request (HARQ) process determination for grant-free transmission with respect to user equipment and network apparatus in mobile communications are described. An apparatus may determine a cyclic shifted version of a base sequence. The apparatus may generate a reference signal based on the cyclic shifted version of the base sequence. The apparatus may transmit a data repetition along with the reference signal on a semi-persistent scheduling (SPS) resource to a network node. The reference signal may be used to identify a repetition index of the data repetition.

### CROSS REFERENCE TO RELATED PATENT APPLICATION(S)

The present disclosure is part of a non-provisional application claiming the priority benefit of U.S. patent application Ser. No. 62/565,183, filed on 29 Sep. 2017, the content of which is incorporated by reference in its entirety.

### TECHNICAL FIELD

The present disclosure is generally related to mobile communications and, more particularly, to repetition and hybrid automatic repeat request (HARQ) process determination for grant-free transmission with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR), ultra-reliable and low latency communications (URLLC) is supported for emerging applications that demands high requirements on end-to-end latency and reliability. A general URLLC reliability requirement for one transmission of a packet is 1-10⁻⁵ for 32 bytes with a user plane latency of 1 ms. For URLLC, the target for user plane latency should be 0.5 ms for uplink and 0.5 ms for downlink.

The uplink grant-free transmission or the semi-persistent scheduling (SPS) transmission can be used to reduce the latency of URLLC services. The user equipment (UE) may be configured to transmit its uplink data on the configured grant without transmitting a prior request to improve the transmission latency. The network may pre-configure specific radio resources (e.g., time and frequency resources) for the UE to perform the SPS/grant-free transmissions.

In order to increase the reliability or the robustness for the URLLC transmissions, the UE may be configured to transmit repetitions for uplink information. For example, uplink grant-free transmissions may be configured with K repetitions in NR. Since the UE may not need a prior request to start the uplink grant-free transmission, the UE may perform the grant-free transmission without any notifications. However, the network apparatus may not know when the initial transmission or the repetition started. The network apparatus may have to attempt to receive the uplink transmission blindly and decode the uplink data blindly. This may cause decoding burdens and uncertainty at the network apparatus. In addition, the network apparatus may also need to identify the hybrid automatic repeat request (HARQ) process of each uplink grant-free transmission for better decoding and increasing the reliability.

Accordingly, how to properly determine the repetition and the HARQ process for the uplink grant-free transmission is an important issue in uplink data decoding. It is needed to provide proper mechanisms to indicate the repetition index and the HARQ process identifier for the uplink grant-free transmission.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to repetition and HARQ process determination for grant-free transmission with respect to user equipment and network apparatus in mobile communications.

In one aspect, a method may involve an apparatus determining a cyclic shifted version of a base sequence. The method may also involve the apparatus generating a reference signal. The method may further involve the apparatus transmitting a data repetition along with the reference signal on an SPS resource to a network node. The reference signal may be used to identify a repetition index of the data repetition.

In one aspect, a method may involve an apparatus receiving a data repetition with a repetition index. The method may also involve the apparatus determining a HARQ process ID according to the repetition index and a repetition pattern. The method may further involve the apparatus decoding data according to the HARQ process ID. The reference signal may be used to identify the repetition index of the data repetition.

In one aspect, an apparatus may comprise a transceiver capable of wirelessly communicating with a plurality of nodes of a wireless network. The apparatus may also comprise a processor communicatively coupled to the transceiver. The processor may be capable of determining a cyclic shifted version of a base sequence. The processor may also be capable of generating a reference signal. The processor may further be capable of transmitting a data repetition along with the reference signal on an SPS resource to a network node. The reference signal may be used to identify a repetition index of the data repetition.

In one aspect, an apparatus may comprise a transceiver capable of wirelessly communicating with a plurality of user equipment of a wireless network. The apparatus may also comprise a processor communicatively coupled to the transceiver. The processor may be capable of receiving a data repetition with a repetition index. The processor may also be capable of determining a HARQ process ID according to the repetition index and a repetition pattern. The processor may further be capable of decoding data according to the HARQ process ID. The reference signal may be used to identify a repetition index of the data repetition.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a block diagram of an example communication apparatus and an example network apparatus in accordance with an implementation of the present disclosure.

FIG. 8 is a flowchart of an example process in accordance with an implementation of the present disclosure.

FIG. 9 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to repetition and HARQ process determination for grant-free transmission with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In NR, the network node may configure two types of uplink grants for the UE to perform uplink transmissions. The uplink grant may indicate some specific radio resources (e.g., time and frequency resources) for the UE to perform uplink transmission. One type of the uplink grant may comprise the dynamic grant. The dynamic grant may be configured based on the UE's request. For example, the UE may transmit a prior request (e.g., service request (SR), random-access channel (RACH) request or buffer status report (BSR)) to the network. After receiving the request, the network may configure the dynamic grant according to UE's request for the UE to perform uplink data transmission.

The other type of the uplink grant may comprise the configured grant. The configured grant may be configured by the network without UE's request. The uplink transmission based on the configured grant may be called the grant-free transmission or the SPS transmission. For example, the uplink grant-free transmission or the SPS transmission may be used to reduce the latency of URLLC services. The UE may be configured to transmit its uplink data on the configured grant without transmitting a prior request to improve the transmission latency. The network may pre-configure specific radio resources (e.g., time and frequency resources) for the UE to perform the SPS/grant-free transmissions.

In order to increase the reliability or the robustness for the URLLC transmissions, the UE may be configured to transmit a plurality of repetitions for uplink information. For example, uplink grant-free transmissions may be configured with K repetitions in NR. Since the UE may not need a prior request to start the uplink grant-free transmission, the UE may perform the grant-free transmission without any notifications. However, the network apparatus may not know when the initial transmission or the repetition started. The network apparatus may have to attempt to receive the uplink transmission blindly and decode the uplink data blindly. This may cause decoding burdens and uncertainty at the network apparatus. In addition, the network apparatus may also need to identify the HARQ process of each uplink grant-free transmission for better decoding and increasing the reliability. Accordingly, how to properly determine the repetition and the HARQ process for the uplink grant-free transmission will be described in the present disclosure.

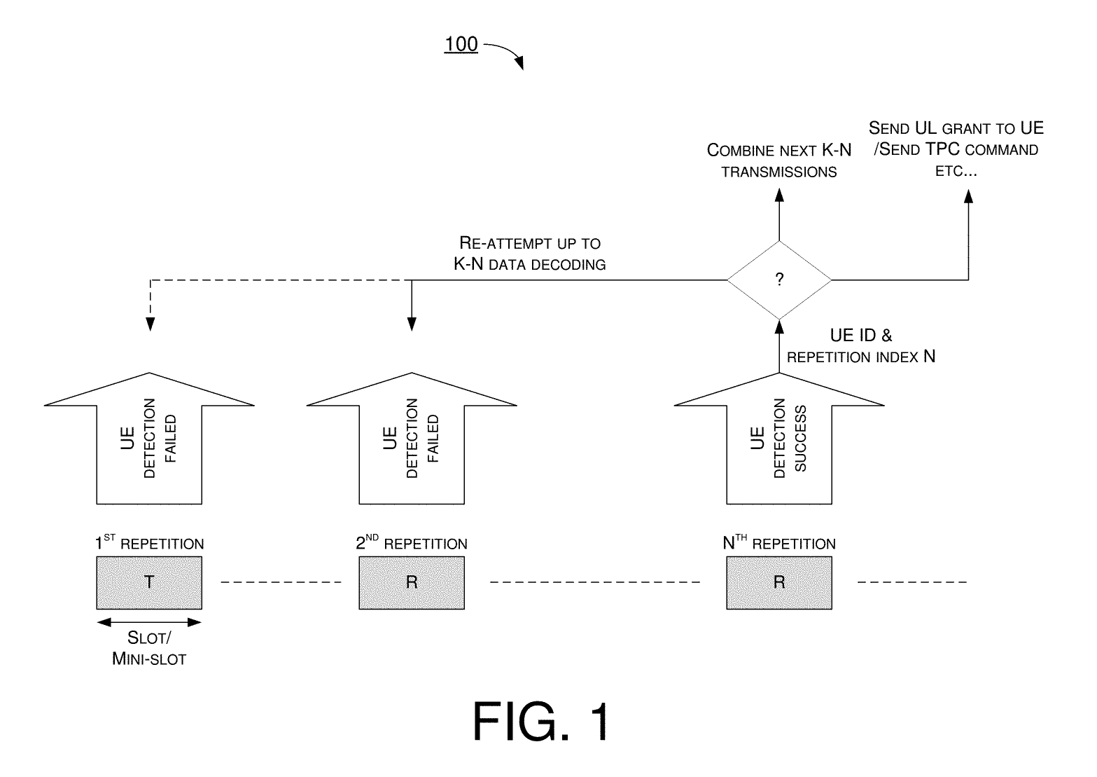

FIG. 1 illustrates an example scenario 100 under schemes in accordance with implementations of the present disclosure. Scenario 100 involves a UE and a network node, which may be a part of a wireless communication network (e.g., an LTE network, an LTE-Advanced network, an LTE-Advanced Pro network, a 5G network, an NR network, an IoT network or an NB-IoT network). The UE may be configured to transmit K repetitions in total for the uplink data to the network node. With the knowledge of the repetition index N (e.g., current repetition index N≤K), the network node may be able to use different strategies according to the UE and the repetition index detection. For example, in a case that previously received data is stored, the network node may attempt to combine/re-decode all the previous N repetitions. The current repetition index N may provide the information on the signals used for the previous repetitions. The network node may continuously combine future repetitions in a case that the data cannot be decoded correctly. The network node may proceed with up to K−N+1 repetition combining for current and future repetitions. Once the uplink data is decoded successfully, the network node may send an uplink grant to the UE for new transmissions or send a transmit power control (TPC) command to the UE.

For the UE transmissions involving the repetition of the initially transmitted data, the UE may be configured to transmit each data repetition along with a repetition index or a repetition identifier (ID). The UE may be configured to use a reference signal to indicate the repetition index or the repetition ID. Specifically, the UE may be configured to determine a cyclic shifted version of a base sequence. The UE may be configured to generate a reference signal. The UE may generate the reference signal based on the cyclic shifted version of the base sequence. The reference signal may comprise a demodulation reference signal (DMRS) based on the cyclic shifted version of the base sequence. Other methods for generating orthogonal DMRS sequences may also be used. The UE may be configured to transmit the data repetition along with the reference signal on the SPS resource or the grant-free transmission resource to the network node. The reference signal may be used by the network node to identify the repetition index of the data repetition. The reference signal may also be used for channel estimation or carrying UE ID. The network node may be able to decode the uplink data according to the repetition index regardless of whether the data transmission follows chase combining or incremental redundancy.

The DMRS signal sequences may be determined by different cyclic shifted versions of a base sequence. For example, the DMRS signal sequence may be defined by the following equations.

$${r}_{g}^{α} ( n ) = {e}^{j ( α \times n )} \overline{{r}_{g}} ( n ) 0 \leq n < {M}_{sc}^{RS}$$

$$α = \frac{2 π \times {n}_{cs}}{{N}_{sbc}} 1 \leq {N}_{min} \leq {N}_{sbc} \leq {N}_{max} \leq {M}_{sc}^{RS}$$

$${n}_{cs} = 0 … {N}_{sbc} - 1$$

r_{g}^{α}(n) denotes the DMRS signal sequence. α denotes the cyclic shift value. r̅_{g}(n) denotes the base sequence. g indexes a particular sequence within a group of sequences that have low inter-correlation properties (e.g. Zadoff-Chu sequences, etc.). Nₘᵢₙ, N_{sbc} and Nₘₐₓ may be either dynamically, semi-statically or statically configured integer values. M_{SC}^{Rs} denotes the number of subcarriers used for the DMRS transmission.

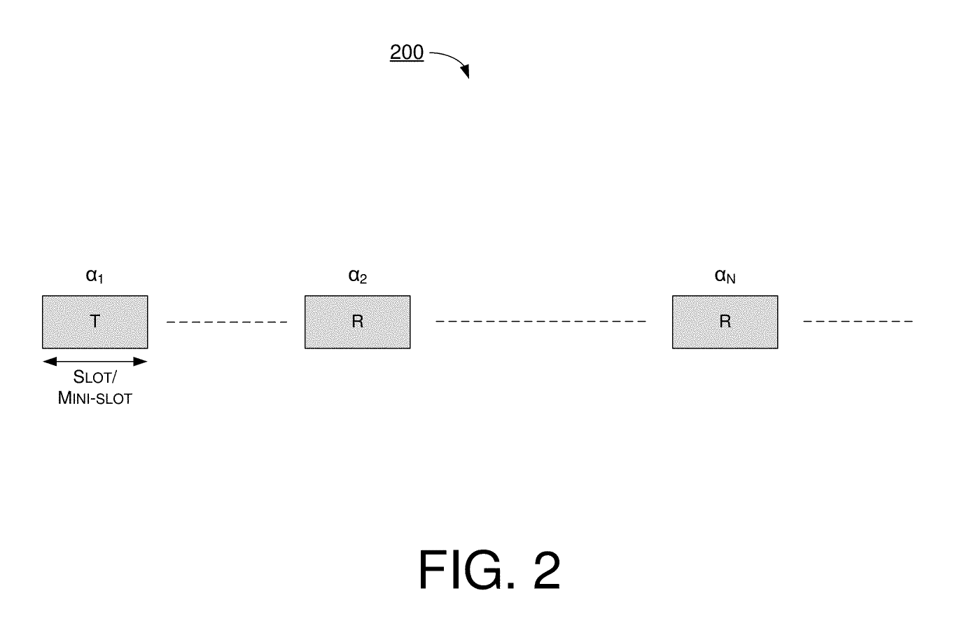

FIG. 2 illustrates an example scenario 200 under schemes in accordance with implementations of the present disclosure. As shown in FIG. 2, each data repetition may be associated with a distinct cyclic shifted version of a given base sequence. Specifically, the UE may be configured to determine a plurality of cyclic shift values (e.g., α₁, α₂ . . . α_{N}). The cyclic shift values may be different from each other. The UE may be configured to determine a plurality of cyclic shifted versions of the base sequence according to the plurality of cyclic shift values. The UE may further generate a plurality of reference signals based on the plurality of cyclic shifted versions of the base sequence. The UE may be configured to use the plurality of reference signals to indicate different repetition indexes by transmitting the data repetitions along with the reference signals. For example, the reference signal associated with α₁ may be used to indicate the first repetition. The reference signal associated with α₂ may be used to indicate the second repetition. The reference signal associated with α_{N} may be used to indicate the N^{th} repetition.

The distance between two consecutive cyclic shifts used for transmitting consecutive repetitions must be large enough to avoid the delay spread affecting the transmission of one repetition to cause the misdetection of the repetition index at the network node. The set of cyclic shifts that may be used for successive repetition may be determined by the following equation.

$$MIN ( \frac{Δ {n}_{CS}}{{N}_{sbc}} ) >> \frac{{δ}_{MAX}}{T}$$

δ_{MAX} denotes the largest channel delay spread affecting the link between the UE and the network node. T denotes the symbol length (i.e., inverse of the subcarrier spacing). N_{sbc} denotes the number of subcarriers achieving a complete unit circle wrap. Δn_{CS} denotes the gap between two cyclic shifts. Accordingly, the gap Δn_{CS} assigned to the repetitions must be large enough to avoid repetition midsection.

For example, N_{sbc}=24 may represent 24 distinct cyclic shifts. With 60 kHz subcarrier spacing, T=16.7 μs. A low/medium delay spread may be assumed as 1 μs. By determining that

$${N}_{sbc} \times \frac{{δ}_{MAX}}{T} = 1.5 ,$$

the distance between consecutive cyclic shifts may be determined to be, for example and without limitation, 4. Accordingly, the cyclic shift value sequence may be determined as 0, 4, 8, 12, 16, 20, 0, 4 . . . (e.g., α₁=0, α₂=4, . . . , α₆=20, etc.). It should be noted that the maximum number of K of repetitions that can be supported without wrapping to the cyclic shift of the initial transmission may be limited by the maximum delay spread affecting the channel (e.g., K may be limited to 6).

In a case that the misdetection probability decreases with the number of transmitted repetitions, the UE may be configured to shuffle the cyclic shift values by increasing the distance between consecutive repetitions. In other words, the UE may be configured to adjust the cyclic shift gap of the reference signal (e.g., DMRS) between two data repetitions. For example, the UE may adjust the cyclic shift gap by changing the cyclic shift value sequence from 0, 4, 8, 12, 16 and 20 to 0, 8, 16, 4, 12 and 20. In a case that missing the first three repetitions has a probability of 10⁻⁶ which is below the URLLC block error rate (BLER) requirement, misdetection of the fourth repetition may have a probability below 10⁻⁶.

In order to enable a greater value for K (e.g., 8), the cyclic shift value sequence which does not comply with the relation

$$MIN ( \frac{Δ {n}_{CS}}{{N}_{sbc}} ) >> \frac{{δ}_{MAX}}{T}$$

may be adjusted by increasing the cyclic shift gap. For example, the sequence with cyclic shift gap of 3 (e.g., 0, 3, 6, 9, 12, 15, 18, 21) may be replaced by the sequence with cyclic shift gap of 9 (e.g., 0, 9, 18, 6, 15, 3, 12, 21). In some implementations, the cyclic shift values which are not equally spaced while still verifying the relation

$$MIN ( \frac{Δ {n}_{CS}}{{N}_{sbc}} ) >> \frac{{δ}_{MAX}}{T}$$

between 2 adjacent repetitions may also be used. For example, the sequence may be determined as 0, 8, 17, 3, 11, 21, 7, etc.

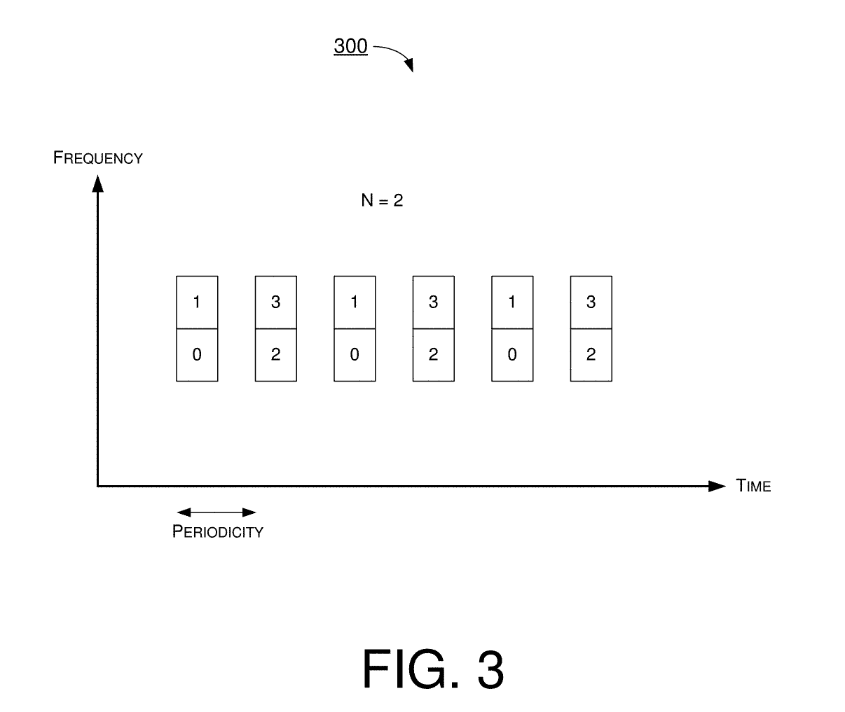

FIG. 3 illustrates an example scenario 300 under schemes in accordance with implementations of the present disclosure. Scenario 300 involves a UE and a network node, which may be a part of a wireless communication network (e.g., an LTE network, an LTE-Advanced network, an LTE-Advanced Pro network, a 5G network, an NR network, an IoT network or an NB-IoT network). FIG. 3 illustrates the mapping between the SPS resources and the HARQ processes. Specifically, the network node may be configured to determine a plurality of SPS resources or grant-free transmission resources. The network node may further map the HARQ process IDs (e.g., 0, 1, 2 and 3) to the SPS resources. Each SPS resource may be associated with a HARQ process ID. More than one SPS resource may be specified within an SPS occasion. For example, different frequency domain resources may be used within one transmission time interval (TTI). Different reference signals may also be used within a TTI. The network node may further specify the number of HARQ process IDs that may share an occasion (e.g., N). For example, 1≤N≤maximum number of HARQ processes. As shown in FIG. 3, N may be determined as 2. The UE may be configured to determine a free HARQ process from the multiple HARQ processes specified for the SPS occasions to perform an initial data transmission. The association between the SPS resources and the HARQ process IDs may be either explicitly specified by the network node or formulaically derived by the UE itself.

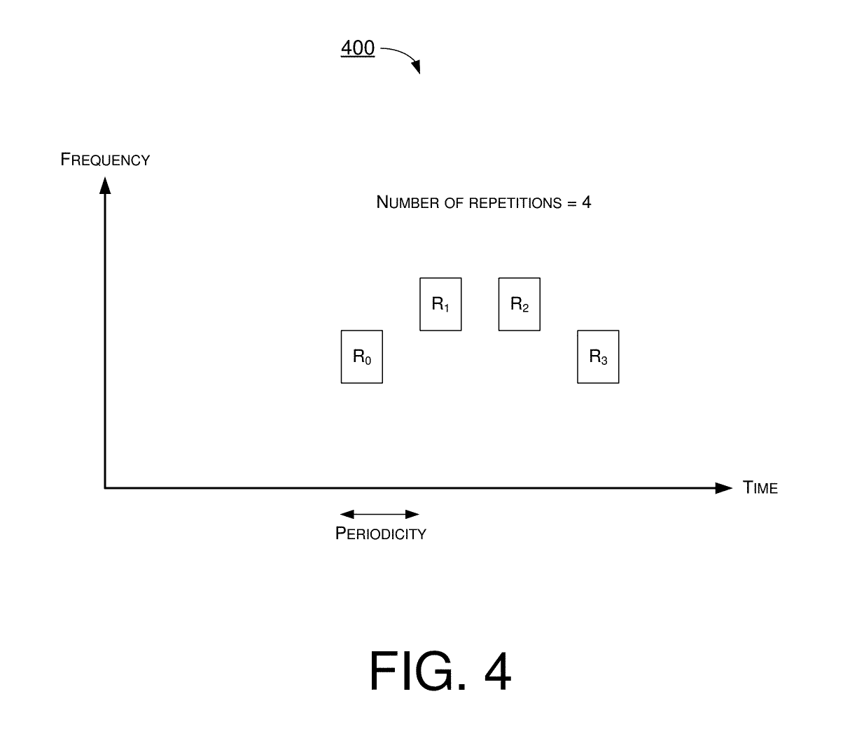

FIG. 4 illustrates an example scenario 400 under schemes in accordance with implementations of the present disclosure. Scenario 400 involves a UE and a network node, which may be a part of a wireless communication network (e.g., an LTE network, an LTE-Advanced network, an LTE-Advanced Pro network, a 5G network, an NR network, an IoT network or an NB-IoT network). FIG. 4 illustrates the repetition pattern configured for the UE. Specifically, the UE may be configured to transmit a plurality of repetitions to the network node. The repetition pattern which specify the SPS resources may be configured for the UE to perform the repetition transmissions. For example, the SPS resource R₀ may be configured for transmitting the first repetition. The SPS resource R₁ may be configured for transmitting the second repetition and so on. The UE may be configured to transmit the data repetitions according to the repetition pattern. The repetition pattern may be either explicitly specified by the network node or formulaically derived by the UE itself.

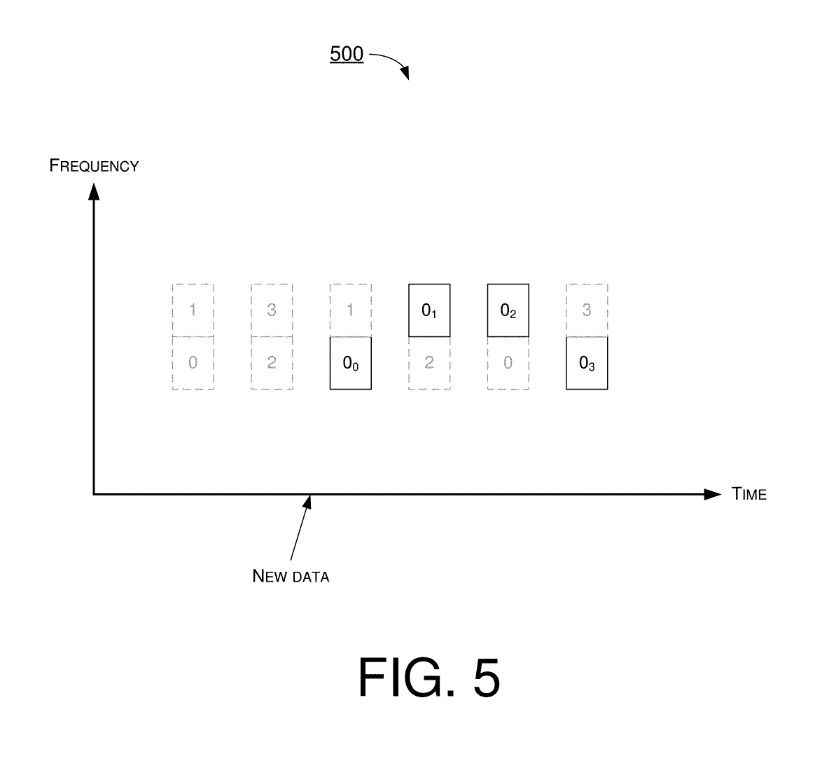

FIG. 5 illustrates an example scenario 500 under schemes in accordance with implementations of the present disclosure. Scenario 500 involves a UE and a network node, which may be a part of a wireless communication network (e.g., an LTE network, an LTE-Advanced network, an LTE-Advanced Pro network, a 5G network, an NR network, an IoT network or an NB-IoT network). The UE may be configured to perform an initial data transmission on the HARQ process associated with the SPS resources. For example, when new data comes, the UE may be configured to determine a free HARQ process on the next SPS resource after new data arrival (e.g., HARQ process ID 0 or 1). The UE may perform the data repetition transmissions with a flexible start. As shown in FIG. 5, the UE pick the HARQ process ID 0 to perform the initial data transmission. The UE transmits the first repetition on the SPS resource 0₀. The UE may be further configured to transmit the subsequent data repetitions on the SPS resources defined by the repetition pattern. For example, the UE may transmit the second repetition on the SPS resource 0₁ and so on. The SPS resource used for the repetition transmissions may not be associated with the same HARQ process as the initial transmission.

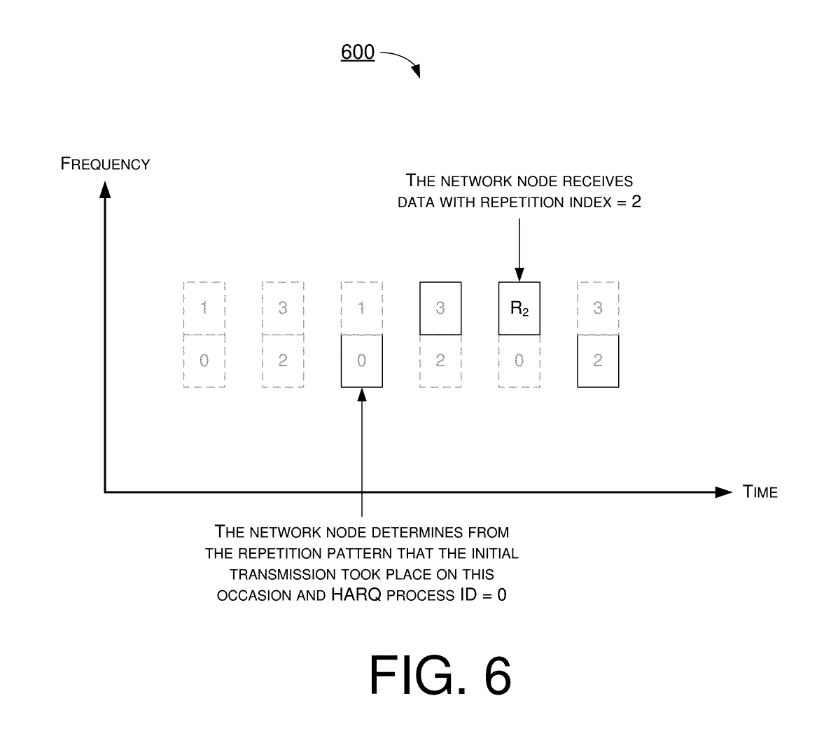

FIG. 6 illustrates an example scenario 600 under schemes in accordance with implementations of the present disclosure. Scenario 600 involves a UE and a network node, which may be a part of a wireless communication network (e.g., an LTE network, an LTE-Advanced network, an LTE-Advanced Pro network, a 5G network, an NR network, an IoT network or an NB-IoT network). On data reception, the network node may receive a data repetition with a repetition index. The network node may be configured to determine the repetition index (e.g., repetition index=2) according to the reference signal along with the data repetition. The reference signal (e.g., DMRS) may be used to identify the repetition index of the data repetition. The network node may determine the SPS resource corresponding to the initial data transmission according to the repetition index and the repetition pattern. Since the HARQ process ID is associated with the SPS resource, the network node may be able to determine the mapping between the HARQ process ID and the SPS resource. The network node may be able to determine the HARQ process ID (e.g., HARQ process ID=0) according to the SPS resource corresponding to the initial data transmission. After determining the HARQ process ID, the network node may be configured to decode the uplink data according to the HARQ process ID. Accordingly, with the information of the repetition index and the HARQ process ID, the decoding at the receiver may become more efficient and precise. The network node may not need to receive the uplink transmission blindly or decode the uplink data blindly. The decoding burdens and the uncertainty at the network node may also be reduced.

### Illustrative Implementations

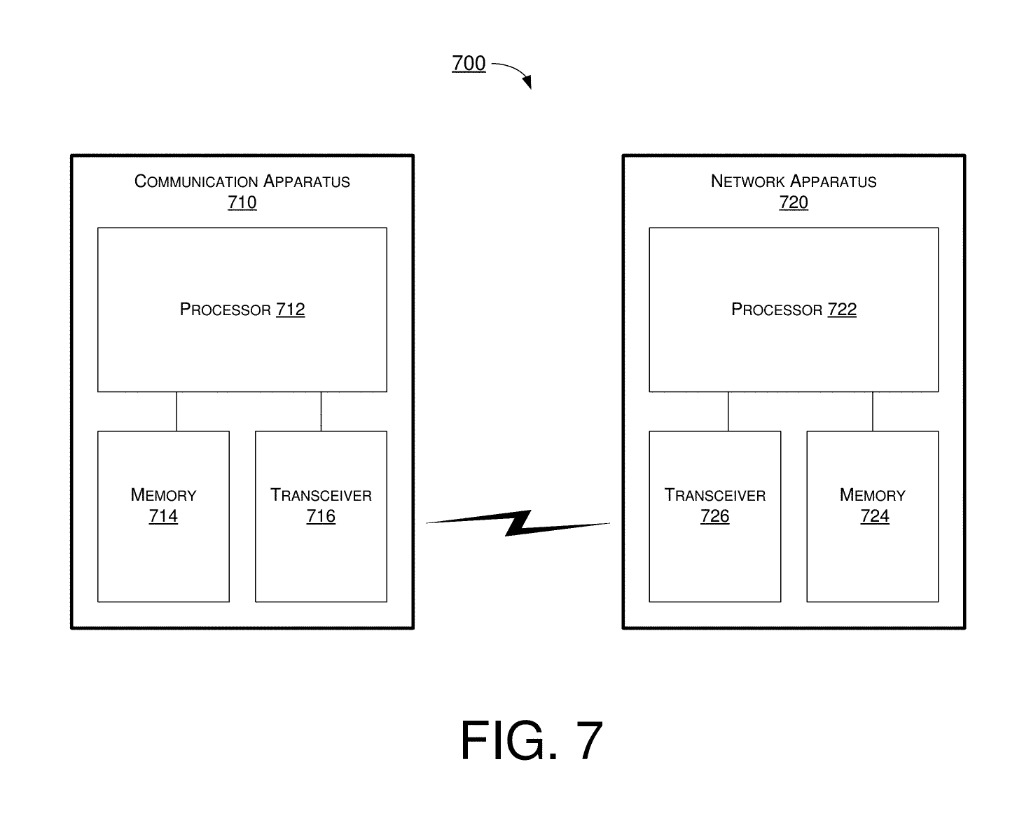

FIG. 7 illustrates an example communication apparatus 710 and an example network apparatus 720 in accordance with an implementation of the present disclosure. Each of communication apparatus 710 and network apparatus 720 may perform various functions to implement schemes, techniques, processes and methods described herein pertaining to repetition and HARQ process determination for grant-free transmission with respect to user equipment and network apparatus in wireless communications, including scenarios 100, 200, 300, 400, 500 and 600 described above as well as processes 800 and 900 described below.

Communication apparatus 710 may be a part of an electronic apparatus, which may be a UE such as a portable or mobile apparatus, a wearable apparatus, a wireless communication apparatus or a computing apparatus. For instance, communication apparatus 710 may be implemented in a smartphone, a smartwatch, a personal digital assistant, a digital camera, or a computing equipment such as a tablet computer, a laptop computer or a notebook computer. Communication apparatus 710 may also be a part of a machine type apparatus, which may be an IoT or NB-IoT apparatus such as an immobile or a stationary apparatus, a home apparatus, a wire communication apparatus or a computing apparatus. For instance, communication apparatus 710 may be implemented in a smart thermostat, a smart fridge, a smart door lock, a wireless speaker or a home control center. Alternatively, communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 710 may include at least some of those components shown in FIG. 7 such as a processor 712, for example. communication apparatus 710 may further include one or more other components not pertinent to the proposed scheme of the present disclosure (e.g., internal power supply, display device and/or user interface device), and, thus, such component(s) of communication apparatus 710 are neither shown in FIG. 7 nor described below in the interest of simplicity and brevity.

Network apparatus 720 may be a part of an electronic apparatus, which may be a network node such as a base station, a small cell, a router or a gateway. For instance, network apparatus 720 may be implemented in an eNodeB in an LTE, LTE-Advanced or LTE-Advanced Pro network or in a gNB in a 5G, NR, IoT or NB-IoT network. Alternatively, network apparatus 720 may be implemented in the form of one or more IC chips such as, for example and without limitation, one or more single-core processors, one or more multi-core processors, or one or more RISC or CISC processors. Network apparatus 720 may include at least some of those components shown in FIG. 7 such as a processor 722, for example. Network apparatus 720 may further include one or more other components not pertinent to the proposed scheme of the present disclosure (e.g., internal power supply, display device and/or user interface device), and, thus, such component(s) of network apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks including power consumption reduction in a device (e.g., as represented by communication apparatus 710) and a network (e.g., as represented by network apparatus 720) in accordance with various implementations of the present disclosure.

In some implementations, communication apparatus 710 may also include a transceiver 716 coupled to processor 712 and capable of wirelessly transmitting and receiving data. In some implementations, communication apparatus 710 may further include a memory 714 coupled to processor 712 and capable of being accessed by processor 712 and storing data therein. In some implementations, network apparatus 720 may also include a transceiver 726 coupled to processor 722 and capable of wirelessly transmitting and receiving data. In some implementations, network apparatus 720 may further include a memory 724 coupled to processor 722 and capable of being accessed by processor 722 and storing data therein. Accordingly, communication apparatus 710 and network apparatus 720 may wirelessly communicate with each other via transceiver 716 and transceiver 726, respectively. To aid better understanding, the following description of the operations, functionalities and capabilities of each of communication apparatus 710 and network apparatus 720 is provided in the context of a mobile communication environment in which communication apparatus 710 is implemented in or as a communication apparatus or a UE and network apparatus 720 is implemented in or as a network node of a communication network.

In some implementations, processor 712 may be configured to transmit, via transceiver 716, K repetitions in total for the uplink data to the network node. With the knowledge of the repetition index N (e.g., current repetition index N≤K), processor 722 may be able to use different strategies according to the communication apparatus and the repetition index detection. For example, in a case that previously received data is stored, processor 722 may attempt to combine/re-decode all the previous N repetitions. The current repetition index N may provide the information on the signals used for the previous repetitions. Processor 722 may continuously combine future repetitions in a case that the data cannot be decoded correctly. Processor 722 may proceed with up to K−N+1 repetition combining for current and future repetitions. Once the uplink data is decoded successfully, processor 722 may send an uplink grant to communication apparatus 710 for new transmissions or send a TPC command to communication apparatus 710.

In some implementations, for the transmissions involving the repetition of the initially transmitted data, processor 712 may be configured to transmit each data repetition along with a repetition index or a repetition ID. Processor 712 may be configured to use a reference signal to indicate the repetition index or the repetition ID. Specifically, processor 712 may be configured to determine a cyclic shifted version of a base sequence. Processor 712 may be configured to generate a reference signal. Processor 712 may generate the reference signal based on the cyclic shifted version of the base sequence. Processor 712 may use the DMRS based on the cyclic shifted version of the base sequence as the reference signal. Other methods for generating orthogonal DMRS sequences may also be used by processor 712. Processor 712 may be configured to transmit, via transceiver 716, the data repetition along with the reference signal on the SPS resource or the grant-free transmission resource to network apparatus 720. Processor 722 may use the reference signal to identify the repetition index of the data repetition. The reference signal may also be used for channel estimation or carrying communication apparatus ID. Processor 722 may be able to decode the uplink data according to the repetition index regardless of whether the data transmission follows chase combining or incremental redundancy.

In some implementations, processor 712 may determine the DMRS signal sequences by different cyclic shifted versions of a base sequence. For example, processor 712 may determine the DMRS signal sequence according to the following equations.

$${r}_{g}^{α} ( n ) = {e}^{j ( α \times n )} \overline{{r}_{g}} ( n ) 0 \leq n < {M}_{sc}^{RS}$$

$$α = \frac{2 π \times {n}_{cs}}{{N}_{sbc}} 1 \leq {N}_{min} \leq {N}_{sbc} \leq {N}_{max} \leq {M}_{sc}^{RS}$$

$${n}_{cs} = 0 … {N}_{sbc} - 1$$

r_{g}^{α}(n) denotes the DMRS signal sequence. α denotes the cyclic shift value. r̅_{g}(n) denotes the base sequence. g indexes a particular sequence within a group of sequences that have low inter-correlation properties (e.g. Zadoff-Chu sequences, etc.). Nₘᵢₙ, N_{sbc} and Nₘₐₓ may be either dynamically, semi-statically or statically configured integer values. M_{SC}^{RS} denotes the number of subcarriers used for the DMRS transmission.

In some implementations, each data repetition may be associated with a distinct cyclic shifted version of a given base sequence. Specifically, processor 712 may be configured to determine a plurality of cyclic shift values (e.g., α₁, α₂ . . . α_{N}). The cyclic shift values may be different from each other. Processor 712 may be configured to determine a plurality of cyclic shifted versions of the base sequence according to the plurality of cyclic shift values. Processor 712 may further generate a plurality of reference signals based on the plurality of cyclic shifted versions of the base sequence. Processor 712 may be configured to use the plurality of reference signals to indicate different repetition indexes by transmitting the data repetitions along with the reference signals. For example, processor 712 may use the reference signal associated with α₁ to indicate the first repetition. Processor 712 may use the reference signal associated with α₂ to indicate the second repetition. Processor 712 may use the reference signal associated with α_{N} to indicate the N^{th} repetition.

In some implementations, processor 712 may determine the set of cyclic shifts that may be used for successive repetition according to the following equation.

$$MIN ( \frac{Δ {n}_{CS}}{{N}_{sbc}} ) >> \frac{{δ}_{MAX}}{T}$$

δ_{MAX} denotes the largest channel delay spread affecting the link between the UE and the network node. T denotes the symbol length (i.e., inverse of the subcarrier spacing). N_{sbc} denotes the number of subcarriers achieving a complete unit circle wrap. Δn_{CS} denotes the gap between two cyclic shifts. Accordingly, the gap Δn_{CS} assigned to the repetitions must be large enough to avoid repetition midsection.

In some implementations, N_{sbc}=24 may represent 24 distinct cyclic shifts. With 60 kHz subcarrier spacing, T=16.7 μs. A low/medium delay spread may be assumed as 1 μs. By determining that

$${N}_{sbc} \times \frac{{δ}_{MAX}}{T} = 1.5 ,$$

processor 712 may determine the distance between consecutive cyclic shifts to be, for example and without limitation, 4. Accordingly, processor 712 may determine the cyclic shift value sequence as 0, 4, 8, 12, 16, 20, 0, 4 . . . (e.g., α₁=0, α₂=4, . . . , α₆=20, etc.).

In some implementations, processor 712 may be configured to shuffle the cyclic shift values by increasing the distance between consecutive repetitions. In other words, processor 712 may be configured to adjust the cyclic shift gap of the reference signal (e.g., DMRS) between two data repetitions. For example, processor 712 may adjust the cyclic shift gap by changing the cyclic shift value sequence from 0, 4, 8, 12, 16 and 20 to 0, 8, 16, 4, 12 and 20.

In some implementations, in order to enable a greater value for K (e.g., 8), processor 712 may adjust the cyclic shift value sequence which does not comply with the relation

$$MIN ( \frac{Δ {n}_{CS}}{{N}_{sbc}} ) >> \frac{{δ}_{MAX}}{T}$$

by increasing the cyclic shift gap. For example, processor 712 may replace the sequence with cyclic shift gap of 3 (e.g., 0, 3, 6, 9, 12, 15, 18, 21) by the sequence with cyclic shift gap of 9 (e.g., 0, 9, 18, 6, 15, 3, 12, 21).

In some implementations, processor 712 may also use the cyclic shift values which are not equally spaced while still verifying the relation

$$MIN ( \frac{Δ {n}_{CS}}{{N}_{sbc}} ) >> \frac{{δ}_{MAX}}{T}$$

between 2 adjacent repetitions. For example, processor 712 may determine the sequence as 0, 8, 17, 3, 11, 21, 7, etc.

In some implementations, processor 722 may be configured to determine a plurality of SPS resources or grant-free transmission resources. Processor 722 may further map the HARQ process IDs (e.g., 0, 1, 2 and 3) to the SPS resources. Each SPS resource may be associated with a HARQ process ID. More than one SPS resource may be specified within an SPS occasion. For example, processor 722 may use different frequency domain resources within one TTI. Processor 722 may also use different reference signals within a TTI. Processor 722 may further specify the number of HARQ process IDs that may share an occasion (e.g., N). Processor 722 may determine that 1≤N≤maximum number of HARQ processes. For example, processor 722 may determine that N=2. Processor 712 may be configured to determine a free HARQ process from the multiple HARQ processes specified for the SPS occasions to perform an initial data transmission. The association between the SPS resources and the HARQ process IDs may be either explicitly specified by processor 722 or formulaically derived by processor 712.

In some implementations, processor 722 may be configured to determine the repetition pattern for communication apparatus 710. Specifically, processor 712 may be configured to transmit a plurality of repetitions to network apparatus 720. Processor 722 may configure the repetition pattern which specify the SPS resources for communication apparatus 710 to perform the repetition transmissions. Processor 712 may be configured to transmit the data repetitions according to the repetition pattern. The repetition pattern may be either explicitly specified by processor 722 or formulaically derived by processor 712.

In some implementations, processor 712 may be configured to perform an initial data transmission on the HARQ process associated with the SPS resources. For example, when new data comes, processor 712 may be configured to determine a free HARQ process on the next SPS resource after new data arrival. Processor 712 may perform the data repetition transmissions with a flexible start. Processor 712 may be further configured to transmit the subsequent data repetitions on the SPS resources defined by the repetition pattern. The SPS resource used for the repetition transmissions may not be associated with the same HARQ process as the initial transmission.

In some implementations, processor 722 may receive a data repetition with a repetition index. Processor 722 may be configured to determine the repetition index according to the reference signal along with the data repetition. Processor 722 may use the reference signal (e.g., DMRS) to identify the repetition index of the data repetition. Processor 722 may determine the SPS resource corresponding to the initial data transmission according to the repetition index and the repetition pattern. Since the HARQ process ID is associated with the SPS resource, processor 722 may be able to determine the mapping between the HARQ process ID and the SPS resource. Processor 722 may be able to determine the HARQ process ID according to the SPS resource corresponding to the initial data transmission. After determining the HARQ process ID, processor 722 may be configured to decode the uplink data according to the HARQ process ID. Accordingly, with the information of the repetition index and the HARQ process ID, the decoding at network apparatus 720 may become more efficient and precise. Processor 722 may not need to receive the uplink transmission blindly or decode the uplink data blindly. The decoding burdens and the uncertainty at network apparatus 720 may also be reduced.

### Illustrative Processes

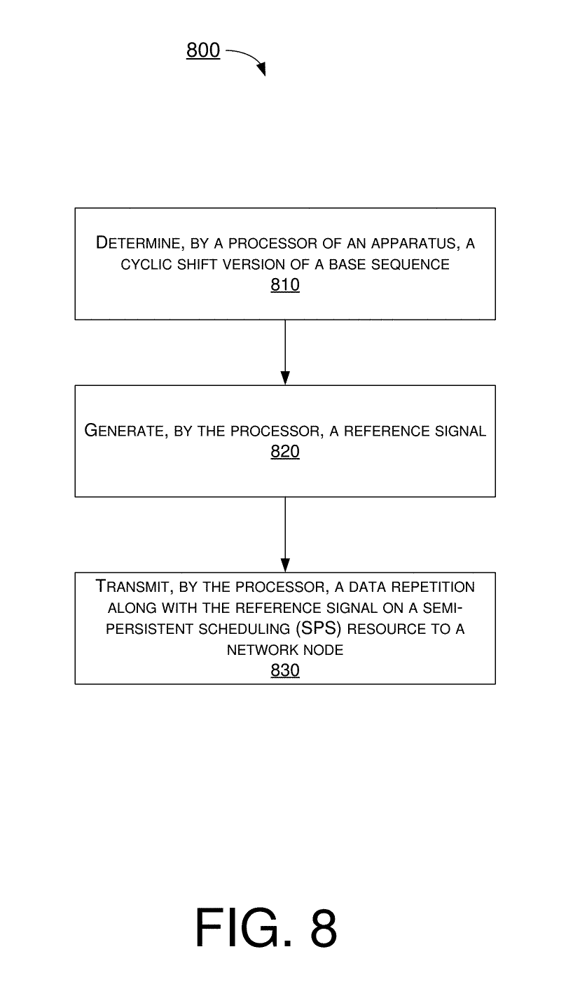

FIG. 8 illustrates an example process 800 in accordance with an implementation of the present disclosure. Process 800 may be an example implementation of scenarios 100, 200, 300, 400, 500 and 600, whether partially or completely, with respect to repetition and HARQ process determination for grant-free transmission in accordance with the present disclosure. Process 800 may represent an aspect of implementation of features of communication apparatus 710. Process 800 may include one or more operations, actions, or functions as illustrated by one or more of blocks 810, 820 and 830. Although illustrated as discrete blocks, various blocks of process 800 may be divided into additional blocks, combined into fewer blocks, or eliminated, depending on the desired implementation. Moreover, the blocks of process 800 may executed in the order shown in FIG. 8 or, alternatively, in a different order. Process 800 may be implemented by communication apparatus 710 or any suitable UE or machine type devices. Solely for illustrative purposes and without limitation, process 800 is described below in the context of communication apparatus 710. Process 800 may begin at block 810.

At 810, process 800 may involve processor 712 of apparatus 710 determining a cyclic shifted version of a base sequence. Process 800 may proceed from 810 to 820.

At 820, process 800 may involve processor 712 generating a reference signal. Process 800 may proceed from 820 to 830.

At 830, process 800 may involve processor 712 transmitting a data repetition along with the reference signal on a SPS resource to a network node. The reference signal may be used to identify a repetition index of the data repetition.

In some implementations, the reference signal may comprise a DMRS based on the cyclic shifted version of the base sequence.

In some implementations, process 800 may involve processor 712 adjusting a cyclic shift gap of the reference signal (e.g., DMRS) between two data repetitions.

In some implementations, process 800 may involve processor 712 determining a HARQ process to perform an initial data transmission. The HARQ process may be associated with the SPS resource.

In some implementations, process 800 may involve processor 712 transmitting the data repetition according to a repetition pattern.

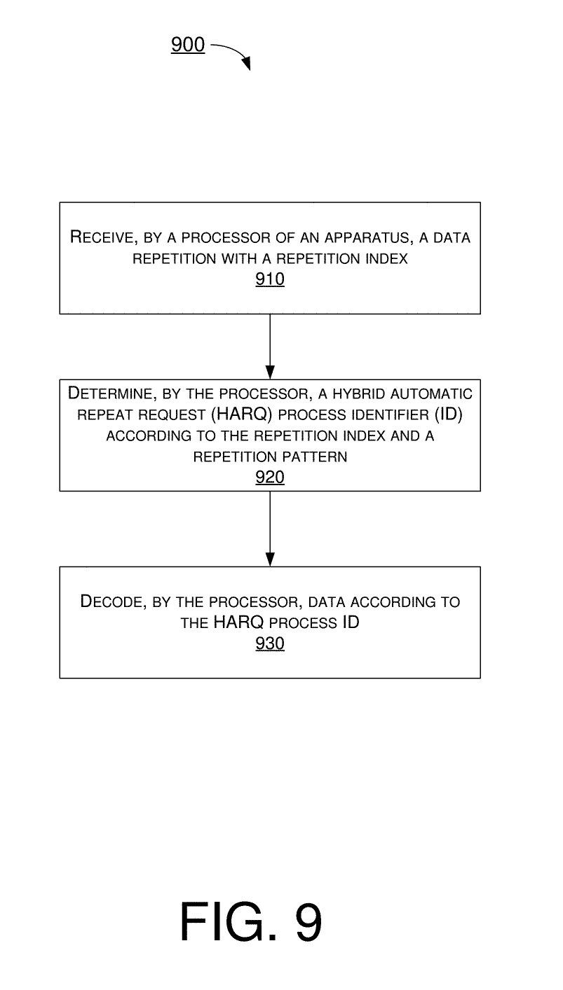

FIG. 9 illustrates an example process 900 in accordance with an implementation of the present disclosure. Process 900 may be an example implementation of scenarios 100, 200, 300, 400, 500 and 600, whether partially or completely, with respect to repetition and HARQ process determination for grant-free transmission in accordance with the present disclosure. Process 900 may represent an aspect of implementation of features of communication apparatus 710. Process 900 may include one or more operations, actions, or functions as illustrated by one or more of blocks 910, 920 and 930. Although illustrated as discrete blocks, various blocks of process 900 may be divided into additional blocks, combined into fewer blocks, or eliminated, depending on the desired implementation. Moreover, the blocks of process 900 may executed in the order shown in FIG. 9 or, alternatively, in a different order. Process 900 may be implemented by communication apparatus 710 or any suitable UE or machine type devices. Solely for illustrative purposes and without limitation, process 900 is described below in the context of communication apparatus 710. Process 900 may begin at block 910.

At 910, process 900 may involve processor 712 of apparatus 710 receiving a data repetition with a repetition index. Process 900 may proceed from 910 to 920.

At 920, process 900 may involve processor 712 determining a HARQ process ID according to the repetition index and a repetition pattern. Process 900 may proceed from 920 to 930.

At 930, process 900 may involve processor 712 decoding data according to the HARQ process ID. The reference signal may be used to identify the repetition index of the data repetition.

In some implementations, process 900 may involve processor 712 determining the repetition index according to a reference signal along with the data repetition.

In some implementations, the reference signal may comprise a DMRS.

In some implementations, process 900 may involve processor 712 determining an SPS resource corresponding to an initial data transmission according to the repetition index and the repetition pattern. Process 900 may further involve processor 712 determining the HARQ process ID according to the SPS resource. The HARQ process ID may be associated with the SPS resource.

In some implementations, process 900 may involve processor 712 determining a mapping between the HARQ process ID and the SPS resource.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a cyclic shifted version of a base sequence;
generating, by the processor, a reference signal; and
transmitting, by the processor, a data repetition along with the reference signal on a semi-persistent scheduling (SPS) resource to a network node,
wherein the reference signal is used to identify a repetition index of the data repetition.

2. The method of claim 1, wherein the reference signal comprises a demodulation reference signal (DMRS) based on the cyclic shifted version of the base sequence.

3. The method of claim 2, further comprising:
adjusting, by the processor, a cyclic shift gap of the DMRS between two data repetitions.

4. The method of claim 1, further comprising:
determining, by the processor, a hybrid automatic repeat request (HARQ) process to perform an initial data transmission,
wherein the HARQ process is associated with the SPS resource.

5. The method of claim 1, wherein the transmitting comprises transmitting the data repetition according to a repetition pattern.

6. A method, comprising:
receiving, by a processor of an apparatus, a data repetition with a repetition index;
determining, by the processor, a hybrid automatic repeat request (HARQ) process identifier (ID) according to the repetition index and a repetition pattern; and
decoding, by the processor, data according to the HARQ process ID,
wherein the reference signal is used to identify the repetition index of the data repetition.

7. The method of claim 6, further comprising:
determining, by the processor, the repetition index according to a reference signal along with the data repetition.

8. The method of claim 7, wherein the reference signal comprises a demodulation reference signal (DMRS).

9. The method of claim 6, further comprising:
determining, by the processor, a semi-persistent scheduling (SPS) resource corresponding to an initial data transmission according to the repetition index and the repetition pattern; and
determining, by the processor, the HARQ process ID according to the SPS resource,
wherein the HARQ process ID is associated with the SPS resource.

10. The method of claim 9, further comprising:
determining, by the processor, a mapping between the HARQ process ID and the SPS resource.

11. An apparatus, comprising:
a transceiver capable of wirelessly communicating with a plurality of nodes of a wireless network; and
a processor communicatively coupled to the transceiver, the processor capable of:
determining a cyclic shifted version of a base sequence;
generating a reference signal; and
transmitting, via the transceiver, a data repetition along with the reference signal on a semi-persistent scheduling (SPS) resource to a network node,
wherein the reference signal is used to identify a repetition index of the data repetition.

12. The apparatus of claim 11, wherein the reference signal comprises a demodulation reference signal (DMRS) based on the cyclic shifted version of the base sequence.

13. The apparatus of claim 12, wherein the processor is further capable of:
adjusting a cyclic shift gap of the DMRS between two data repetitions.

14. The apparatus of claim 11, wherein the processor is further capable of:
determining a hybrid automatic repeat request (HARQ) process to perform an initial data transmission,
wherein the HARQ process is associated with the SPS resource.

15. The apparatus of claim 11, wherein, in the transmitting the data repetition, the processor is further capable of transmitting the data repetition according to a repetition pattern.

16. An apparatus, comprising:
a transceiver capable of wirelessly communicating with a plurality of user equipment of a wireless network; and
a processor communicatively coupled to the transceiver, the processor capable of:
receiving, via the transceiver, a data repetition with a repetition index;
determining a hybrid automatic repeat request (HARQ) process identifier (ID) according to the repetition index and a repetition pattern; and
decoding data according to the HARQ process ID,
wherein the reference signal is used to identify a repetition index of the data repetition.

17. The apparatus of claim 16, wherein the processor is further capable of:
determining the repetition index according to a reference signal along with the data repetition.

18. The apparatus of claim 17, wherein the reference signal comprises a demodulation reference signal (DMRS).

19. The apparatus of claim 16, wherein the processor is further capable of:
determining a semi-persistent scheduling (SPS) resource corresponding to an initial data transmission according to the repetition index and the repetition pattern; and
determining, by the processor, the HARQ process ID according to the SPS resource,
wherein the HARQ process ID is associated with the SPS resource.

20. The apparatus of claim 19, wherein the processor is further capable of:
determining a mapping between the HARQ process ID and the SPS resource.
